(19) United States
(12) Patent Application Publication
(10) Pub. No.: US 2005/0224555 A1
(43) Pub. Date: Oct. 13, 2005

(54) Stapler with inside leg support

(75) Inventors: David W. Kirby, Lemont, IL (US); Bikramjeet S. Sohi, Buffalo Grove, IL (US); Stephen J. Gaynes, McHenry, IL (US); Richard J. Page, Lake Villa, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 11/097,365

(22) Filed: Apr. 1, 2005

Related U.S. Application Data
(60) Provisional application No. 60/559,207, filed on Apr. 2, 2004.

(51) Int. Cl. B25C 5/02

(52) U.S. Cl. 227/134

(57) ABSTRACT

A stapler including a staple support device. The stapler includes a base, a magazine for holding staples having a front portion, and a staple driver for driving staples out of the magazine in a staple driving plane. The stapler also includes a nose piece coupled to the front portion of the magazine and a support device coupled to the nose piece. Staples in the magazine are supported on an outer surface by the magazine and on an inner surface by the support device.

### CROSS-REFERENCE TO RELATED APPLICATIONS

This application claims priority to U.S. Provisional Patent Application No. 60/559,207, filed Apr. 2, 2004, the entire contents of which are incorporated by reference herein.

### FIELD OF THE INVENTION

The invention relates to staplers.

### BACKGROUND OF THE INVENTION

Manual desk staplers, including heavy duty staplers, include a staple holding chamber to facilitate adding more staples to the stapler. The staple holding chamber, also known as the magazine, provides support to outside portions of a staple that is being driven into a stack of sheets to be stapled.

### SUMMARY OF THE INVENTION

The invention provides an improved stapler including a device for providing support to the inside of the legs of a staple and the crown of the staple to be driven.

In one embodiment, the invention provides a stapler including a base and a magazine coupled to the base for holding staples. The magazine includes a front portion. The stapler further includes a staple driver for driving staples out of the magazine in a staple driving plane. A nose piece is coupled to the front portion of the magazine. The nose piece includes a front wall including slots and an offset protrusion. A support device includes a top portion that is coupled to the protrusion of the nose piece, and fingers that extend through the slots in the nose piece. The fingers are adapted to move out of the staple driving plane as the staples are driven out of the magazine. The protrusion of the nose piece is offset from the staple driving plane such that the coupling of the top portion of the support device to the protrusion does not interfere with the operation of the staple driver.

In another embodiment, the invention provides a stapler including a base and a magazine coupled to the base for holding staples. The magazine includes a front portion. The stapler further includes a staple driver for driving staples out of the magazine in a staple driving plane. A nose piece is coupled to the front portion of the magazine and a support device is coupled to the nose piece. The support device includes fingers that extend through slots in the nose piece. The fingers are adapted to move out of the staple driving plane as the staples are driven out of the magazine. The support device is coupled to the nose piece to substantially prevent twisting or rotation of the support device with respect to the nose piece that could otherwise cause misalignment between the fingers and the slots. In one embodiment, the support device is coupled to the nose piece by two fasteners.

The invention also provides a method of supporting a staple during operation of a stapler that is constructed in the manners described above.

Other features and advantages of the invention will become apparent to those skilled in the art upon review of the following detailed description, claims, and drawings.

### BRIEF DESCRIPTION OF THE DRAWINGS

FIG. 1 is a perspective view illustrating the stapler embodying the invention.

FIG. 2 is a partial perspective view of a magazine of the stapler of FIG. 1.

FIG. 3 is a rear partial perspective view of the magazine of FIG. 2.

FIG. 4 is a rear view of the magazine of FIG. 2.

FIG. 5 is an exploded view of the magazine of FIG. 2.

FIG. 6 is a perspective view of a support device used in the stapler of FIG. 1.

FIG. 7 is a section view of the magazine taken along line 7-7 of FIG. 4 before the stapler is actuated.

FIG. 8 is a section view similar to FIG. 7, taken as the stapler is actuated.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items.

### DETAILED DESCRIPTION OF THE PREFERRED EMBODIMENT

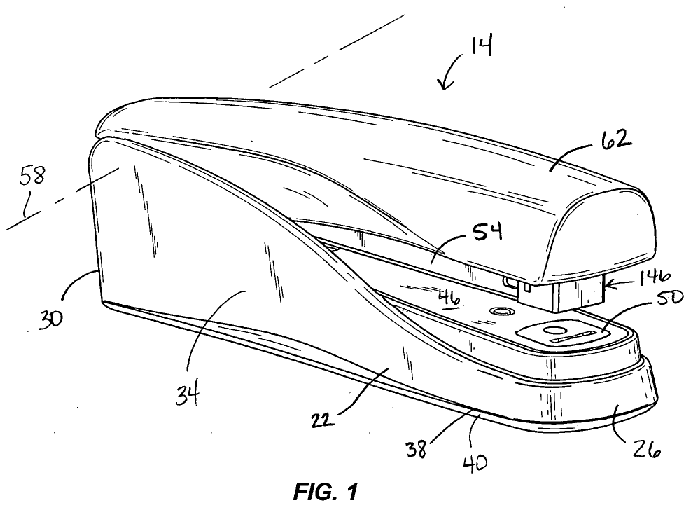

FIG. 1 illustrates a stapler 14 according to the invention. In the embodiment illustrated in FIG. 1, the stapler 14 is a manual desktop-type stapler. However, the invention can be practiced with substantially any type of stapler, including, but not limited to, manual hand-held or upright staplers, manual heavy-duty staplers, and all forms of electric staplers, including desktop-type, heavy-duty, and hand-held electric staplers.

The illustrated stapler 14 includes a base 22 having a front end 26, a rear end 30, and opposite sides 34. A bottom 38 of the base is at least partially covered by a slipper or pad 40 that helps stabilize and minimize sliding movement of the stapler 14 on a support surface (not shown). The base 22 further includes a top surface 46 for receiving and supporting a stack of sheets (not shown) to be stapled. An anvil 50 is supported by the top surface 46 for clinching staples driven through the stack of sheets. As used herein and in the appended claims, the terms “top”, “bottom”, “upper”, “lower”, “right”, “left”, “front”, “rear”, and the like are intended facilitate description of the illustrated embodiments, and are not intended to imply or require any particular orientation.

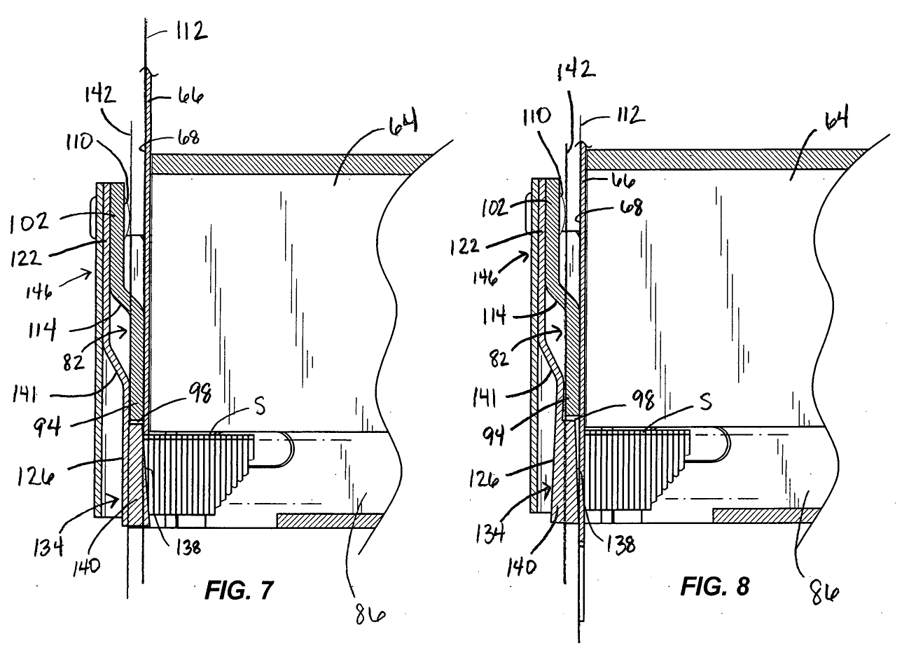

A staple magazine 54 is pivotally connected to the rear end 30 of the base 22 about a pivot axis 58, as is understood in the art. A cover 62 is also pivotally connected to the base 22 about the pivot axis 58, and is capable of pivoting both with the magazine 54 and with respect to the magazine 54 during stapling operations. The cover 62 also pivots away from the magazine 54 to facilitate re-filling the magazine 54 with staples. A case 64 (see FIG. 7) is also pivotally connected to the base 22 about the pivot axis 58. The case 64 at least partially closes the upper portion of the magazine 54 when the cover 62 is in the closed position, and pivots with the cover 62 to the open position for re-filling the magazine 54 with staples.

The stapler 14 also includes a driver 66 (shown in FIGS. 7 and 8) mounted to the case 64 to drive the staples S out of the stapler 14 into the stack of sheets. The front surface 68 of the driver 66 defines a plane of movement in which the driver 66 moves downwardly to drive the staple S out of the stapler 14.

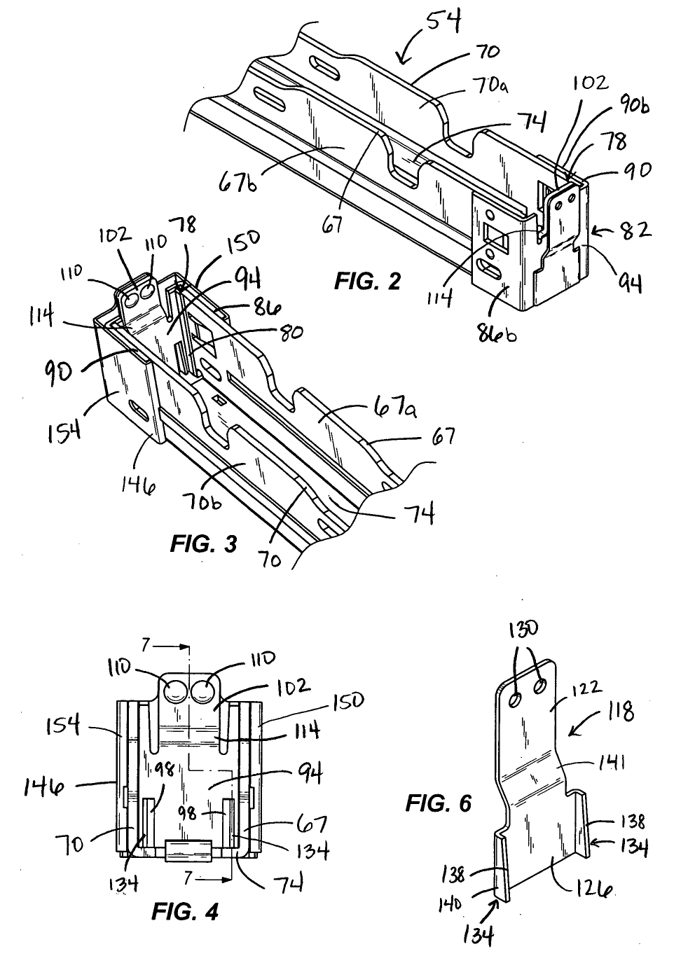

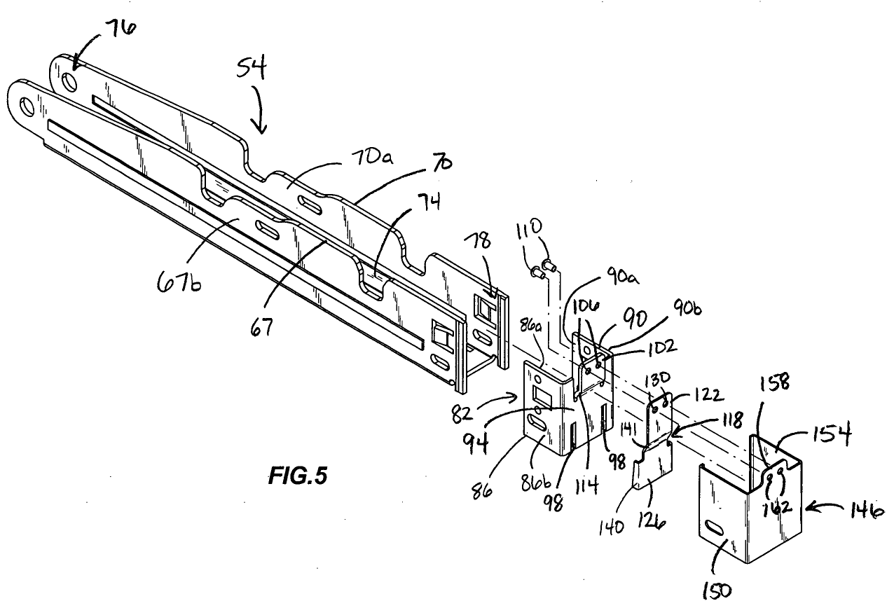

With reference to FIGS. 2-5, the magazine 54 includes a first side wall 67 defining interior 67a and exterior 67b surfaces and a second side wall 70 defining interior 70a and exterior 70b surfaces. The side walls 67 and 70 are coupled together by a bottom wall 74, and are spaced apart a distance approximately equal to the width of the staples to be used with the stapler 14. The magazine 54 also includes a rear portion 76 (shown in FIG. 5) that is pivotally connected to the rear end 30 of the base 22, and a front portion 78 defining vertical surfaces 80 (only one is shown in FIG. 3). Staples S (shown in FIGS. 7 & 8) are inserted into the magazine 54 and are supported on the outside staple leg surfaces by the respective interior surfaces 67a, 70a of the first and second side walls 67, 70 as the staples move through the magazine 54. During stapling, the outside surfaces of the staple legs are further supported by the slightly narrowed vertical surfaces 80 of the front portion 78.

A nose piece 82 is coupled to the front portion 78 of the magazine 54. As best illustrated in FIG. 5, the nose piece 82 includes a first side wall 86 defining interior 86a and exterior 86b surfaces, and a second side wall 90 defining interior 90a and exterior 90b surfaces. The interior surfaces 86a and 90a cooperate with and are coupled to the respective exterior surfaces 67b, 70b of the first and second side walls 67, 70 of the magazine 54. The nose piece 82 also includes a front wall 94 that encloses the front portion 78 of the magazine 54 and provides support to the front surface of the staple S. While the illustrated nose piece 82 is shown as being a separate component from the magazine 54, the nose piece 82 could also be integrally formed as part of the magazine 54, and thereby still define a nose piece 82 coupled to the magazine 54.

As illustrated in FIGS. 4 and 5, the front wall 94 includes two slots 98 extending therethrough, the function of which will be described in more detail below. The front wall 94 also includes a protrusion 102 that includes two apertures 106 for receiving fasteners, such as rivets 110. It is understood that other suitable fasteners can also be used, such as a screw, a bolt, a pin, or other fasteners.

The front wall 94 includes a bent portion 114 extending between the protrusion 102 and the remainder of the front wall 94. The protrusion 102 is offset from a plane 112 (see FIGS. 7 and 8) defined by the rear surface of the front wall 94 due to the bent portion 114 to ensure that the rivets 110 do not break the plane 112 or interfere with the operation of the driver 66.

The stapler 14 also includes a device for supporting the inside surfaces of the staples S. In the illustrated embodiment, the device is a metal support spring 118. However, it is understood that in other embodiments, the device can have other configurations. It is also understood that in other embodiments, the support spring can be made of other materials, such as plastics, hardened rubber, etc.

With particular reference to FIG. 6, the support spring 118 includes a top portion 122 and a bottom portion 126. The top portion 122 includes two apertures 130 that cooperate with the apertures 106 in the front wall 94 of the nose piece 82 for receiving the rivets 110 to couple the support spring 118 to the front wall 94. By using two rivets 110 to couple the support spring 118 to the front wall 94 instead of only a single rivet 110, the support spring 118 is substantially prevented from twisting or rotating with respect to the front wall 94 in a manner that might otherwise cause misalignment between the below-described fingers 134 and the slots 98. As mentioned above, other types of fasteners can be substituted for the rivets 110. Additionally, other methods for coupling the support spring 118 to the front wall 94 of the nose piece 82 can also be employed. For example, the top portion 122 and the protrusion 102 can be coupled together by swaging, welding, or by other coupling techniques. Such techniques can also substantially prevent twisting or rotating of the support spring 118 with respect to the front wall 94.

The bottom portion 126 includes fingers 134 that are configured to extend through the slots 98 in the front wall 94 when the support spring 118 is coupled to the front wall 94. With reference to FIG. 4, the fingers 134 have a width that is smaller than the width of the slots 98 to ensure that the fingers 134 can pass through the slots 98, and reduce wear on the fingers 134. The fingers 134 each include a ramped upper surface 138 and an outer surface 140. The upper surface 138 is configured such that the lower portion of each finger 134 extends further into the slots 98 than the upper portion of each finger 134. The ramped upper surface 138 supports the inner surface of the crown of the staple S during stapling, while the outer surface 140 supports the inside or inner surface of the staple legs when the fingers 134 extend through the slots 98 into the magazine 54.

The support spring 118 also includes a bent portion 141 extending between the top and bottom portions 122, 126. Similar to the bent portion 114 of the front wall 94, the bent portion 141 offsets the top portion 122 from a plane 142 defined by the rear surface of the bottom portion 126 to ensure that the rivets 110 do not interfere with the operation of the driver 66. By offsetting the protrusion 102 and the top portion 122 from the plane 112, the coupling of the support spring 118 to the nose piece 82 (using the rivets 110 or any of the alternative techniques discussed above) will not interfere with the operation of the driver 66. However, it is understood that in other embodiments the spring can have other configurations to ensure proper function of the stapler and appropriate flexibility, and may not include a bent portion.

With reference to FIGS. 3-5, the stapler 14 also includes a tie plate 146 coupled to the front of the support spring 118. The tie plate 146 includes first and second side walls 150, 154 that are configured to cooperate with the first and second side walls 86, 90 of the nose piece 82. The tie plate 146 also includes a protrusion 158 that has two apertures 162 that cooperate with the apertures in the support spring 118 and front wall 94 to receive the rivets 110 to couple the tie plate 146 to the support spring 118 and the front wall 94. Just as described above with respect to the nose piece 82 and the support spring 118, the tie plate 146 can also be coupled to the support spring 118 and the nose piece 82 using other suitable fasteners or coupling techniques.

With reference to FIGS. 7 and 8, the stapler 14 and support spring 118 can be used to perform a method of supporting a staple while stapling. The fingers 134 of the support spring 118 extend through the slots 98 such that the outer surfaces 140 support the inside surface of the legs of the staple S. As the driver 66 pushes the staple S out of the stapler 14, the inner surface of a crown 166 of the staple S contacts the ramped upper surfaces 138 of the fingers 134. The force of the driver 66 acting upon the ramped upper surfaces 138 causes the fingers 134 to move (e.g., pivot) at least partially out of the slots 98 and out of the plane 112 occupied by the driver 66 to allow the staple S to pass through the stapler 14 into the stack of sheets. The design of the support spring 118 and front wall 94 allow the front wall 94, support spring 118, and tie plate 146 to be firmly coupled together using the rivets 110 (or other suitable coupling techniques) without interfering with the function of the driver 66. The design also provides sufficient flexibility of the support spring 118 to move or pivot out of the way of the staple S as the staple S is driven from the stapler 14, and allows the spring 118 to move or pivot within the confined space between the front surface 68 of the driver 66 and the tie plate 146.

Various features of the invention are set forth in the following claims.

1. A stapler comprising:
a base;
a magazine coupled to the base for holding staples, the magazine having a front portion;
a staple driver for driving staples out of the magazine in a staple driving plane;
a nose piece coupled to the front portion of the magazine, the nose piece including a front wall including slots and an offset protrusion; and
a support device including a top portion that is coupled to the protrusion of the nose piece, and fingers that extend through the slots in the nose piece, the fingers adapted to move out of the staple driving plane as the staples are driven out of the magazine;
wherein the protrusion of the nose piece is offset from the staple driving plane such that the coupling of the top portion of the support device to the protrusion does not interfere with the operation of the staple driver.

2. The stapler of claim 1, wherein the top portion of the support device is coupled to the protrusion by a fastener, and wherein the fastener is offset from the staple driving plane such that the fastener does not interfere with the operation of the staple driver.

3. The stapler of claim 2, wherein the fastener includes two fasteners such that the support device does not substantially twist or rotate when coupled to the nose piece.

4. The stapler of claim 2, wherein the fastener is a rivet.

5. The stapler of claim 1, further comprising a tie plate coupled to the support device and the nose piece.

6. The stapler of claim 5, wherein the stapler includes space between the tie plate and the nose piece such that the fingers of the support device can move out of the slots into the space between the tie plate and the nose piece.

7. The stapler of claim 1, wherein the fingers have a width that is smaller than a width of the slots in the nose piece.

8. The stapler of claim 1, wherein the fingers each have a ramped upper surface.

9. The stapler of claim 1, wherein the support device includes a leaf spring.

10. The stapler of claim 1, wherein the fingers of the support device are on a bottom portion of the support device that is offset from the top portion of the support device by a bent portion.

11. The stapler of claim 1, wherein the nose piece is a separate component coupled to the magazine.

12. A stapler comprising:
a base;
a magazine coupled to the base for holding staples, the magazine having a front portion;
a staple driver for driving staples out of the magazine in a staple driving plane;
a nose piece coupled to the front portion of the magazine; and
a support device coupled to the nose piece, the support device including fingers that extend through the slots in the nose piece, the fingers adapted to move out of the staple driving plane as the staples are driven out of the magazine;
wherein the support device is coupled to the nose piece to substantially prevent twisting or rotation of the support device with respect to the nose piece.

13. The stapler of claim 12, wherein the support device is coupled to the nose piece by two fasteners.

14. The stapler of claim 12, wherein the nose piece includes a front wall having a protrusion offset from the staple driving plane, and wherein the support device is coupled to the protrusion such that the coupling of the support device to the nose piece does not interfere with the operation of the staple driver.

15. The stapler of claim 14, wherein the support device includes a top portion that is coupled to the protrusion of the nose piece by two fasteners.

16. The stapler of claim 14, wherein the support device includes a top portion that is coupled to the protrusion, and wherein the fingers of the support device are on a bottom portion of the support device that is offset from the top portion of the support device by a bent portion.

17. The stapler of claim 12, wherein the support device includes a leaf spring.

18. The stapler of claim 12, wherein the magazine includes first and second side walls, and wherein the nose piece is coupled to the first and second side walls of the magazine.

19. The stapler of claim 12, wherein the nose piece is a separate component coupled to the magazine.

20. The stapler of claim 12, wherein the fingers have a width that is less than a width of the slots in the nose piece.

21. The stapler of claim 12, wherein the fingers each have a ramped upper surface.

22. A method of supporting a staple during operation of a stapler, the method comprising:
providing a magazine for holding staples and a staple driver for driving staples out of the magazine in a staple driving plane;
coupling a nose piece to a front portion of the magazine, the nose piece including a protrusion offset from the staple driving plane;
coupling a support device to the nose piece by coupling a top portion of the support device to the protrusion of the nose piece such that the coupling does not interfere with the operation of the staple driver and such that the support device is substantially prevented from twisting and rotating with respect to the nose piece, the support device including fingers that extend through slots in the nose piece;
actuating the staple driver to drive a staple out of the staple magazine into a stack of sheets;
supporting an outer surface of the staple with the magazine as the staple is driven out of the magazine; and
moving the fingers at least partially out of the slots as the driver drives the staple into the stack of sheets, the fingers supporting an inner surface of the staple as the staple is driven out of the magazine.

23. The method of claim 22, further comprising coupling a tie plate to the support device such that a space is defined between the nose piece and the tie plate, and wherein moving the fingers at least partially out of the slots in the nose piece includes moving the fingers into the space created between the nose piece and the tie plate.

24. The method of claim 22, wherein coupling the nose piece to the front portion of the magazine includes coupling a separate nose piece component to the front portion of the magazine.

25. The method of claim 22, wherein the fingers support an inner surface of legs of the staple.

26. The method of claim 22, wherein the fingers support an inner surface of a crown of the staple.
